(19) United States
(12) Patent Application Publication
(10) Pub. No.: US 2007/0139770 A1
(43) Pub. Date: Jun. 21, 2007

(54) Polarizing glass

(75) Inventors: Shozo Morimoto, Niigata (JP); Masahiro Ichimura, Niigata (JP); Yuich Aoki, Niigata (JP)

Correspondence Address: OSHA LIANG L.L.P., 1221 MCKINNEY STREET, SUITE 2800, HOUSTON, TX, 77010, US

(73) Assignee: Arisawa Mfg. Co., Ltd., Niigata (JP)

(21) Appl. No.: 11/417,077

(22) Filed: May 3, 2006

Related U.S. Application Data
(60) Provisional application No. 60/714,544, filed on Dec. 16, 2005.

(51) Int. Cl. G02B 5/30

(52) U.S. Cl. 359/490

(57) ABSTRACT

In order to be able to obtain polarizing glass having favorable polarization characteristics in the visible light region, there is provided polarizing glass which is obtained by dispersing and orienting metal particles having anisotropy in shape within base glass and which exhibits dichroism, wherein the base glass is transparent glass whose absorption edge of incident light is 350 nm or less when wavelength is converted into a variable, a real number part of dielectric constant of the metal is minus or crosses over 0 with energy higher than 3.5 eV when the energy is converted into a variable and reflectivity of the metal is 80% or more in the visible light region.

### CROSS REFERENCE TO RELATED APPLICATION

The present application claims priority from a U.S. Provisional Application No. 60/714,544 filed on Dec. 16, 2005, the contents of which are incorporated herein by reference.

### BACKGROUND OF THE INVENTION

1. Field of the Invention

The present invention relates to polarizing glass that may be used for imaging apparatuses such as a liquid crystal TV receiver, a liquid crystal projector and the like.

2. Background Art

While various types of polarizers for linearly polarizing light have been known, polarizing glass that is a polarizer made of glass, e.g., aluminoborosilicate glass, has been known as an absorption type polarizer, i.e., as what exhibits dichroism. The polarizing glass may be obtained by elongating glass containing metal particles such as silver and copper to elongate and orient the metal particles dispersed and contained in the glass into the shape of ellipsoid as disclosed in Japanese Patent Laid-Open Nos. 2004-86100 and 1996-50205.

The polarizing glass is utilized mainly in the field of optical communications and is used for an optical isolator for optical communications for example. Parts used for the optical communications are required to have very high reliability and only parts that pass severe tests are adopted, so that the reliability of the polarizing glass is being proved. However, although the polarizing glass has such high reliability, its use is limited almost to the near infrared region that is the wavelength region of optical communications and it is barely used in the visible light region such as the field of liquid crystal. It is because the polarizing glass has had the following problems in using in the visible light region.

FIG. 1 shows transmittance of TM and TE waves when they are incident respectively on polarizing glass in which elliptical silver particles are dispersed and oriented. Here, the TE wave (S-wave) is a wave whose electric field oscillates vertically to a major axis of the elliptic metal particle and the TM wave (P-wave) is a wave whose electric field oscillates in parallel to the major axis of the elliptic metal particle. Transmittance of the polarizing glass implies transmittance of the TE wave and a contrast ratio implies a ratio of the transmittance of the TE wave and that of the TM wave. Accordingly, as shown in FIG. 1, the polarizing glass in which the elliptic silver particles are dispersed and oriented has characteristics that among RGB wavelength regions in the visible light region, transmittance of light in the wavelength region of G (in the neighborhood of 500 nm) is low and transmittance of light and the contrast ratio in the wavelength region of B (in the neighborhood of 400 nm) is low. Therefore, although the polarizing glass in which the elliptic silver particles are dispersed and oriented exhibits favorable polarizing characteristics in the specific wavelength region of the visible light region, the polarizing characteristics of light mainly in the wavelength region of B is a problem.

Meanwhile, polarizing glass in which elliptic copper particles are disposed and oriented has no wavelength region in which the transmittance of the TE and TM waves is reversed like the polarizing glass in which the elliptic silver particles are dispersed and oriented. However, its transmittance becomes 40% or less almost across the whole wavelength regions of G and B and the transmittance becomes 30% or less especially in the wavelength region of B. Accordingly, the contrast ratio becomes low in these wavelength regions.

Because the polarizing glass in which the elliptic silver or copper particles are dispersed and oriented has the problem that the transmittance and contrast ratio are low in the specific wavelength region in the visible light region as described above, no polarizing glass that exhibits favorable polarization characteristics in the whole RGB wavelength regions has been obtained yet.

Accordingly, it is an object of the invention to provide polarizing glass that is capable of solving the above-mentioned problem. This object may be achieved through the combination of features described in independent claims of the invention. Dependent claims thereof specify preferable embodiments of the invention.

### SUMMARY OF THE INVENTION

In order to solve the above-mentioned problem, according to a first aspect of the invention, there is provided a polarizing glass which includes a base glass exhibiting dichroism and formed of a transparent glass whose absorption edge of incident light is equal to or less than 350 nm when wavelength is converted into a variable, and metal having anisotropic shape dispersed and oriented within said base glass, a real number part of dielectric constant of said metal being minus or crosses over 0 with energy higher than 3.5 eV when the energy is converted into a variable, and reflectivity of said metal being equal to or higher than 80% in the visible light region. It enables the polarizing glass to have the favorable polarizing characteristics in the visible light region.

Preferably, plasma resonance absorption of a TE wave to the polarizing glass takes place to the TE wave having energy higher than 4.0 eV. It brings about the polarizing glass having the high transmittance of the TE wave on the short wavelength side in particular within the visible light region.

Preferably, plasma resonance absorption of a TM wave to the polarizing glass takes place to the TM wave having energy higher than 1.2 eV. It brings about the polarizing glass having excellent extinction characteristics of the TE wave in the visible light region.

Preferably, the transmittance of the polarizing glass in the visible light region is 65% or more. It allows the polarizing glass having the high transmittance in the visible light region to be obtained.

Preferably, a contrast ratio of the polarizing glass in the visible light region is 100:1 or more. It allows the polarizing glass having the excellent contrast ratio in the visible light region to be obtained.

In the polarizing glass, preferably the absorption edge of the metal exists on the high-energy side higher than the absorption edge of the base glass when the energy is converted into a variable. It allows the polarizing glass having the high transmittance across the whole transmission wavelength region of the base glass to be obtained.

In the polarizing glass, preferably an aspect ratio of the metal particle is 1.5:1 or more. It allows the polarizing glass having the excellent extinction characteristics of the TM wave to be obtained.

In the polarizing glass, the metal may include at least aluminum or indium. It allows the favorable polarizing characteristics to be obtained in the visible light region.

According to a second aspect of the invention, there is provided a polarizing glass which includes a base glass exhibiting dichroism and formed of a transparent glass in which an absorption edge of incident light is equal to or less than 350 nm when wavelength is converted into a variable, and metal dispersed and oriented within said base glass, the metal comprising at least one of aluminum and indium. It brings about the same effect with the first aspect of the invention.

It is noted that the summary of the invention described above does not necessarily describe all necessary features of the invention. The invention may also be a sub-combination of the features described above.

### BRIEF DESCRIPTION OF THE DRAWINGS

FIG. 1 is a graph showing transmittance of TM and TE waves when they are incident respectively on polarizing glass in which elliptical silver particles are dispersed and oriented.

FIG. 2 is a graph showing reflectivity characteristics of gold, silver and copper to incident wavelength.

FIG. 3 is a graph showing the reflectivity characteristics of silver (Ag), lead (Pb), indium (In) and aluminum (Al).

FIG. 4 is a graph, with regard to lead (Pb), showing a relationship between γ/NV and energy of incident light in polarizing glass in which metal particles having various aspect ratios are dispersed and oriented.

FIG. 5 is a graph, with regard to aluminum (Al), showing the relationship between γ/NV and energy of incident light in the polarizing glass in which metal particles having various aspect ratios are dispersed and oriented.

FIG. 6 is a graph, with regard to indium (In), showing the relationship between γ/NV and energy of incident light in the polarizing glass in which metal particles having various aspect ratios are dispersed and oriented.

FIG. 7 is a graph showing a relationship between aspect ratios of silver (Ag), aluminum (Al) and indium (In) particles and energy by which the TM wave in that aspect ratio exhibits plasma resonance absorption.

FIG. 8 is a diagrammatic view of a liquid crystal projector that is another example of an embodiment.

### DETAILED DESCRIPTION OF THE INVENTION

The invention will now be described based on preferred embodiments, which do not intend to limit the scope of the invention, but exemplify the invention. All of the features and the combinations thereof described in the embodiments are not necessarily essential to the invention.

As a result of deliberate study on characteristics of metal dispersed and oriented in polarizing glass, the inventors et. al. of the present invention have found characteristics of metal that brings about polarizing glass that exhibits favorable polarizing characteristics in the whole RGB wavelength regions.

The characteristics of metal that brings about the polarizing glass exhibiting the favorable polarizing characteristics will be explained below.

The polarizing glass utilizes dichroism of the metal dispersed and oriented within or on the surface of base glass. The dichroism is a nature of metal that a spectral absorption coefficient to linear polarized light having one optical axis incident on the polarizing glass is different from a spectral absorption coefficient to linear polarized light orthogonal to that linear polarized light and a difference of the respective spectral absorption coefficients differs depending on types of metal. Accordingly, metal that exhibits small absorption to one linear polarized light and exhibits large absorption to the other linear polarized light is suitable for the polarizing glass. Here, plasma resonance absorption of metal significantly contributes to the larger absorption. E That is, because most of incident light is absorbed to the metal on the level of energy that exhibits the plasma resonance absorption, transmittance of the polarizing glass in which the metal is dispersed and oriented becomes low. Such plasma resonance absorption is considered to happen due to inter-band transition caused within the metal. According to the Lorentz's theory, the inter-band transition occurs under involvement of electronic polarization caused within metal when light is incident on the metal, so that the plasma resonance absorption is related with dielectric constant of the metal. Here, the dielectric constant (∈) is represented by a complex number of ∈=∈₁+i∈₂. The real number part is related with tendency of causing polarization and the imaginary number part represents a loss (absorption of light). It is noted that energy is inversely proportional to a wavelength of electromagnetic wave including light.

The metal exhibits the plasma resonance absorption regardless of the shape of the metal whether it is globular or elliptical. However, when the shape of the metal is elliptical, energy that exhibits the plasma resonance absorption differs depending on the aspect ratio (major axis/minor axis) that is a ratio of the major axis to the minor axis of the ellipsoid and its tendency is different by the TE wave and TM wave. Here, the energy that exhibits the plasma resonance absorption of the TM wave shifts to the low-energy side as the aspect ratio becomes large, i.e., as the metal particle becomes long and thin. Meanwhile, the energy that exhibits the plasma resonance absorption of the TE wave is almost constant even though it shifts slightly to the high-energy side from the energy level that exhibits the plasma resonance absorption when the aspect ratio is 1 as the aspect ratio becomes large. Accordingly, the metal exhibits no dichroism when its shape is globular and exhibits dichroism when its shape is elliptical.

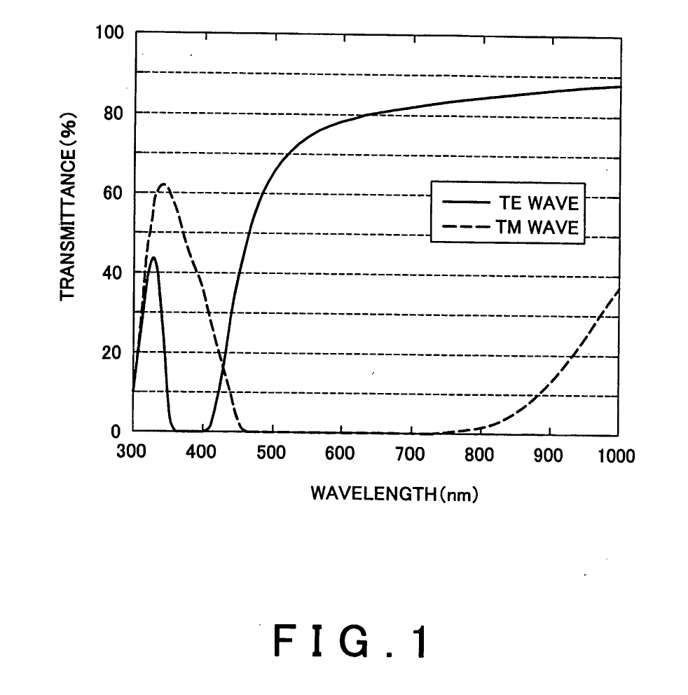

In case of silver for example, it exhibits the plasma resonance absorption with about 3.1 eV (in the neighborhood of 400 nm), when its aspect ratio is 1, i.e., when it is globular. The polarizing glass in which silver particles whose aspect ratio is larger than 1, i.e., elliptical silver particles, are dispersed and oriented exhibits the polarizing characteristics as shown in FIG. 1. That is, the TM wave exhibits the plasma resonance absorption on the low-energy side (long wavelength side) lower than 3.1 eV and its transmittance becomes low and the TE wave exhibits the plasma resonance absorption in the neighborhood of 3.1 eV and its transmittance becomes low.

Meanwhile, according to the Drude's theory, when light is incident on metal, the electric field of the electromagnetic wave is immediately canceled within the metal due to the action of free electrons within the metal, so that the electric field of the light is cut off. Accordingly, the light cannot enter the matter and causes strong reflection. At this time, the real number part of the dielectric constant in the wavelength region of light becomes minus and the reflectivity is very high. Basically, it has been known that when the imaginary number part (∈₂) of the dielectric constant is +∞(∈₂→+∞), the reflectivity becomes R→1. Here, in the dielectric constant characteristics of metal, when ∈₂→+∞, the real number part becomes ∈₁→−∞, so that it is apparent that light cannot enter the metal and causes the strong reflection when the real number part is minus. In other words, when ∈₁→0 the reflectivity drops. Then, in the actual metal, because dispersion of the dielectric constant (plasma resonance absorption) caused by inter-band transition based on the Lorenz's theory described above is superimposed besides the influence caused by the plasma oscillation of free electrons, the real number part of the dielectric constant ∈₁˜0 and it becomes plus by crossing over 0 with specific energy when the energy is seen as a variable. This phenomenon is called as hybrid plasma. The energy level of light when the real number part of the dielectric constant crosses over 0 due to this hybrid plasma is called as an absorption edge. The most of the light incident on the metal is absorbed in the neighborhood of such absorption edge, so that the reflectivity of the metal drops remarkably.

In FIG. 1, the energy of silver of the absorption edge is about 3.8 eV (in the neighborhood of 320 nm) and the transmittance of the polarizing glass in which silver particles are dispersed and oriented drops remarkably on the high-energy side (short wavelength side) which is higher than this energy level regardless of the shape of the silver particles or of the polarizing direction of the incident light such as the TE and TM waves.

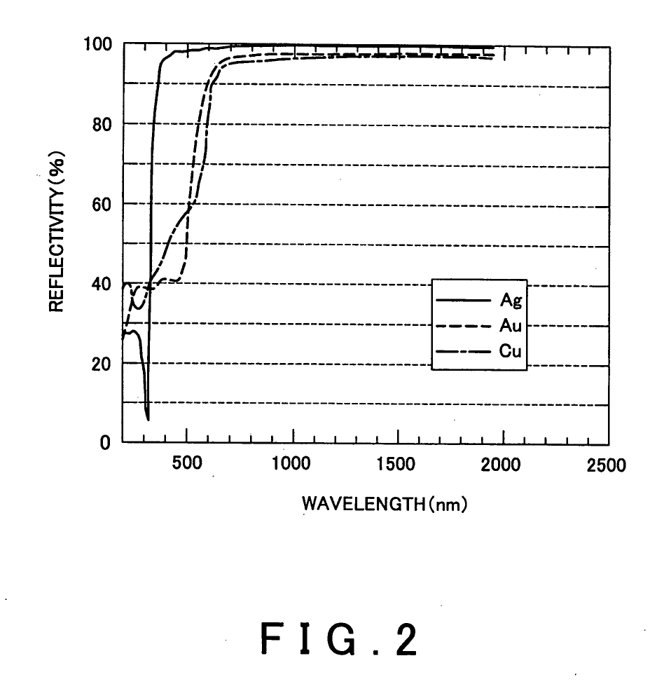

FIG. 2 is a graph showing reflectivity characteristics of gold, silver and copper to the incident wavelength. As shown in FIG. 2, unlike the reflectivity of silver, the reflectivity of gold and copper does not drop remarkably at specific incident wavelength. It is considered to happen because the real number part of the dielectric constant does not cross over 0 on the specific energy level like silver. However, the drop of reflectivity of gold and copper is seen on the high-energy side from about 3 eV (in the neighborhood of 412 nm) and about 2 eV (in the neighborhood of 619 nm), which are energy levels where the inter-band transition begins, respectively. Accordingly, while some metal have clear absorption edge due to the hybrid plasma and the other metal have no clear absorption edge, it is considered that the reflectivity drops on the energy level where the inter-band transition is considered to begin in either cases.

When energy of incident light is seen as a variable, the absorption edge exists also in the base glass, i.e., the mother glass containing no metal, used for the polarizing glass. The absorption edge of aluminoborosilicate glass that is one example of the base glass used for the polarizing glass is 4.6 eV (about 270 nm). Because such base glass exhibits transmittance of 90 % or more on the low-energy side (long wavelength side) lower than 3.5 eV (about 350 nm), the base glass exhibits very high transmittance in the visible light region. An absorption edge of lead glass is 3.5 eV (about 350 nm). Because such base glass exhibits transmittance of 70% or more on the low-energy side (long wavelength side) lower than 3.1 eV (about 400 nm), the base glass exhibits comparatively high transmittance in the visible light region.

From the study described above, it has been found that a first condition of preferable metal to be used for the polarizing glass by dispersing and orienting within the base glass is that the real number part of the dielectric constant does not cross over 0 or it crosses over 0 on the high-energy side (short wavelength side) higher than 3.5 eV (about 350 nm) which is the absorption edge of the base glass or more preferably, it crosses over 0 on the high-energy side (short wavelength side) higher than 4.6 eV (about 270 nm). Thereby, the absorption edge of metal comes to the high-energy side higher than the absorption edge of the base glass when the energy is converted into a variable. Therefore, even if ellipsoids of such metal are dispersed and oriented within the base glass, the drop of transmittance of incident light caused by the mixture of such metal is considered to be small at least on the short wavelength side of the visible light region.

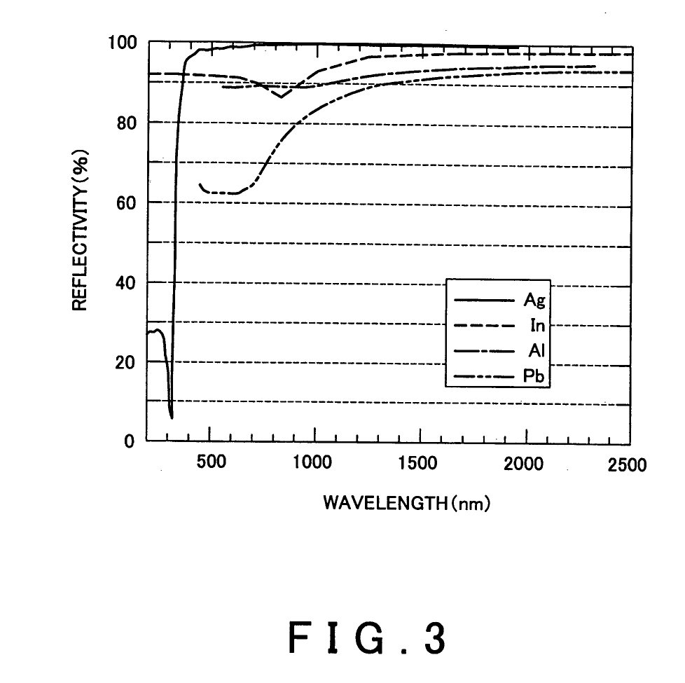

As described above, the real number part of the dielectric constant of metal increases in connection with the beginning of the inter-band transition and the reflectivity drops on the energy level where the inter-band transition is considered to begin. Accordingly, the increase/decrease of the real number part of the dielectric constant of metal is considered to have a relationship of inverse proportion with the increase/decrease of the reflectivity. Then, the inventors studied on changes of the real number part of the dielectric constant with respect to energy of incident light by watching changes of reflectivity with respect to energy of incident light for various metals. FIG. 3 is a graph showing the reflectivity characteristics of silver (Ag), lead (Pb), indium (In) and aluminum (Al). In FIG. 3, Al and In have no significant drop of reflectivity when energy is seen as a variable. Accordingly, Al is considered that the real number part of the dielectric constant does not cross over 0 at least in the visible light region. Although In is seen to have the similar tendency with Al, it was unable to obtain data of reflectivity on the short wavelength side shorter than 550 nm. Accordingly, Al and In meet with the first condition suitable for the polarizing glass based on FIG. 3.

In addition to the first condition described above, a second condition of preferable metal for the polarizing glass is that when the metal is dispersed and oriented within the polarizing glass as metal particles having a specific aspect ratio, the polarizing glass exhibits the plasma resonance absorption to the TM wave and exhibits no plasma resonance absorption to the TE wave in the visible light region. Then, the inventors further studied whether or not the polarizing glass exhibits the plasma resonance absorption corresponding to the aspect ratio by utilizing the Gans' theory when In and Al particles are dispersed and oriented respectively within the polarizing glass while comparing with other metals. According to the Gans' theory, a relationship of an extinction coefficient and aspect ratio with the energy level that exhibits the plasma resonance absorption may be found from the aspect ratio of metal, the dielectric constant of metal and the dielectric constant of glass. Here, the extinction coefficient is a measure for representing a degree of attenuation of amplitude of electric field of incident light within metal and energy of incident light by which the extinction coefficient becomes highest corresponds to the energy that exhibits the plasma resonance absorption.

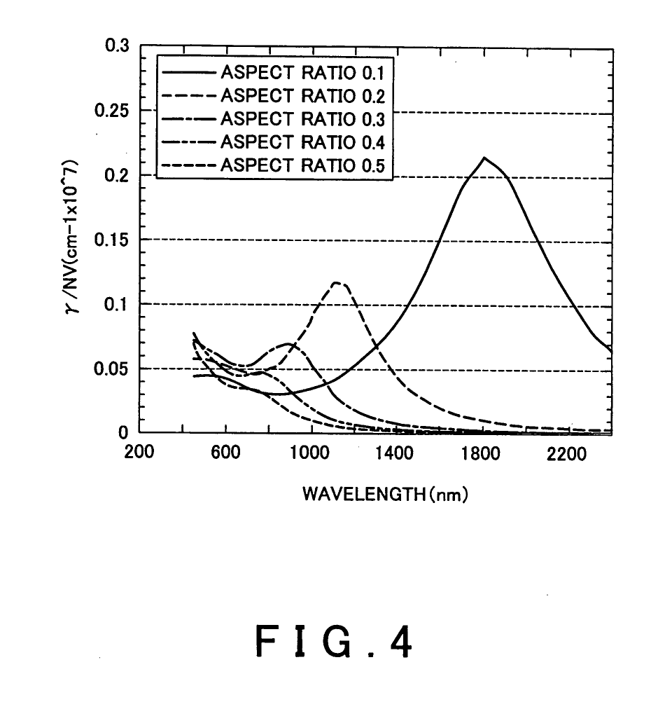

FIGS. 4 through 6 are graphs, with regard to lead (Pb), aluminum (Al) and indium (In), showing a relationship between /NV and energy of incident light in the polarizing glass in which metal particles having various aspect ratios (minor axis/major axis) are dispersed and oriented. γ/NV is a value obtained by dividing the extinction coefficient (γ) found from the Gans' theory described above by a number of particles (N) per unit volume of the polarizing glass in which the respective metal particle are dispersed and oriented and by volume (V) of the respective particles. The aspect ratio mentioned here implies the minor axis/major axis of the particle and also implies that the smaller the aspect ratio is, the longer the particle becomes. Therefore, it has a relation of inverse number with the aspect ratio described above. In the Gans' theory, metal exhibits the plasma resonance absorption clearly on the energy level where the above value (γ/NV) presents the peak and the transmittance of the TM wave becomes fully low with this energy. Meanwhile, the metal does not exhibit the plasma resonance absorption clearly on the energy level where the above value (γ/NV) has no peak and the transmittance of the TM wave does not become fully low. However, because the energy, which has the apparent dielectric constant in the respective metals, is discontinuous, the peaks of the above value (γ/NV) in FIGS. 4 through 6 do not coincide completely with the wavelength where the plasma resonance absorption is maximized.

As shown in FIG. 4, although the above value (γ/NV) of Pb exhibits the peak corresponding to the aspect ratio in the infrared region, it exhibits no peak in the visible light region. Accordingly, an absorption factor of the TM wave of the polarizing glass in which elliptical Pb particles are dispersed and oriented is considered to be not so high in the visible light region. Still more, the reflectivity of Pb is low in the visible light region in FIG. 3. That is, the inter-band transition is considered to be beginning from around 1500 nm in Pb and as a result, the reflectivity drops gradually toward the short wavelength side. Then, the TE wave is considered to exhibit the plasma resonance absorption due to the influence of the hybrid plasma in the visible light region. Accordingly, the polarizing glass in which Pb particles are dispersed and oriented is considered that the transmittance of the TE wave is low in the visible light region. Due to that, the contrast ratio that is the ratio of the transmittance of the TE wave and that of the TM wave is considered to be low.

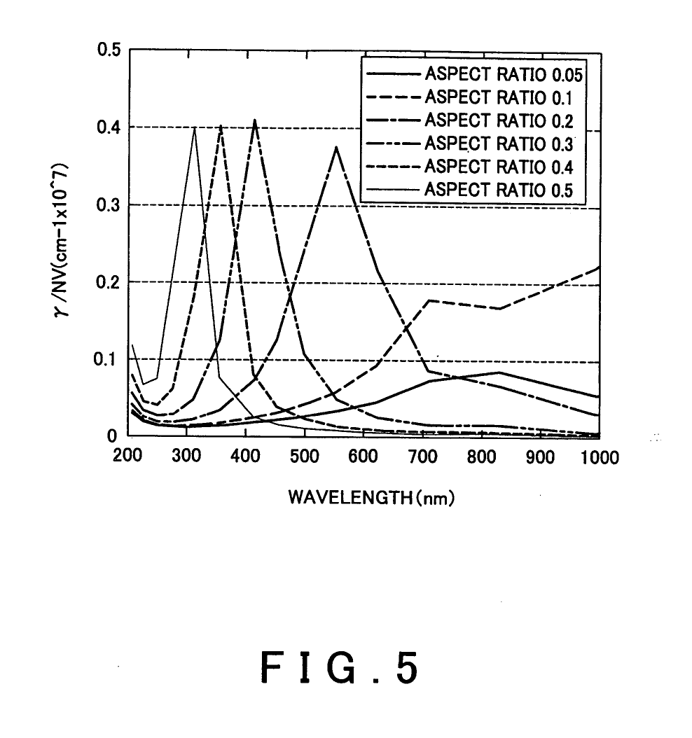

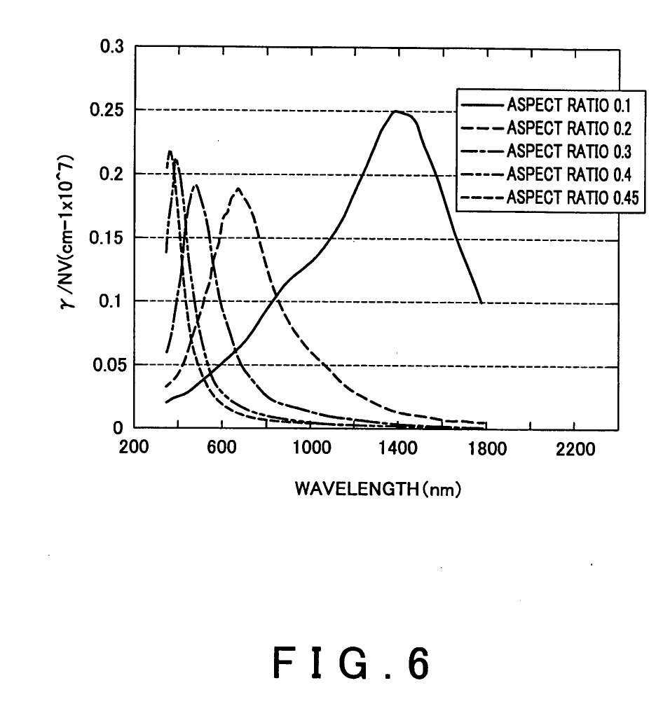

Meanwhile, Al exhibits the plasma resonance absorption corresponding to the aspect ratio in the wavelength of 600 nm or less as shown in FIG. 5, so that its absorption factor of the TM wave is considered to be fully high in this wavelength region. Still more, In exhibits the plasma resonance absorption corresponding to the aspect ratio across the whole visible light region as shown in FIG. 6, so that its absorption factor of the TM wave is considered to be fully high in the visible light region.

When molybdenum (Mo), lead (Pb), palladium (Pd), rhodium (Rh), and ruthenium (Ru) were specified as metals having the absorption edge on the high-energy side (short wavelength side) higher than the visible light region to check the existence of the plasma resonance absorption in the same manner with what described above, none of the metals exhibited the plasma resonance absorption in the visible light region. It is noted that the reflectivity of these metals is 80% or less in the wavelength regions of about 1200 nm or less, about 900 nm or less, about 1000 nm or less, about 600 nm or less and about 1300 nm or less, respectively.

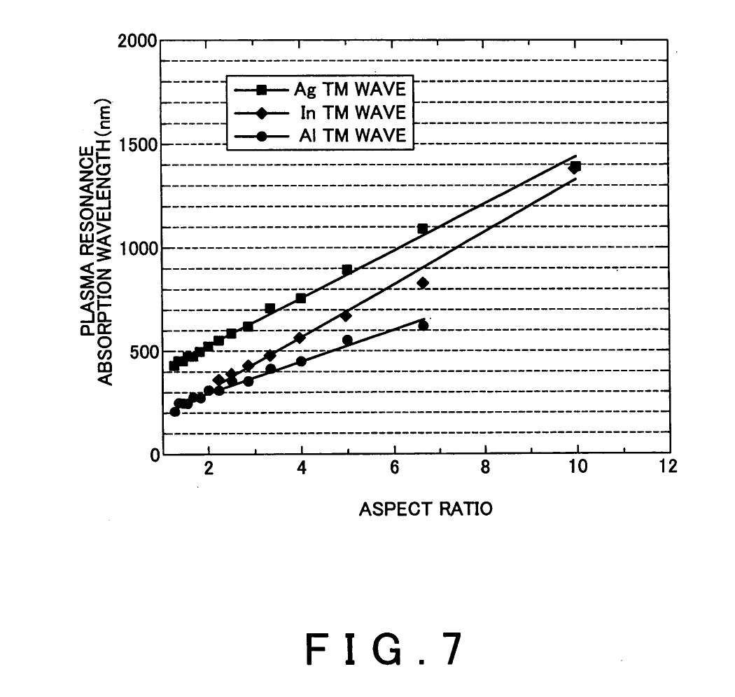

FIG. 7 is a graph showing a relationship between the aspect ratios of silver (Ag), aluminum (Al) and indium (In) and the energy level where the TM wave in that aspect ratio exhibits the plasma resonance absorption. As shown in FIG. 7, the relationship between the aspect ratios of the metals and the energy level where the TM wave exhibits the plasma resonance absorption is approximately proportional. Accordingly, the energy level that exhibits the plasma resonance absorption when the aspect ratio in FIG. 7 is 1 is energy level where the transmittance of the TE wave in the polarizing glass using that metal becomes low. Here, the both wavelengths representing the energy described above when the aspect ratios of Al and In are 1 are assumed to be about 200 nm as shown in FIG. 7. Accordingly, the transmittances of TE wave of both Al and In do not drop in the visible light region and the polarizing glass in which elliptical Al and In particles are dispersed and oriented is considered to have high transmittance of the TE wave across the whole transmission wavelength region of the base glass.

From the study described above, it has been found that the second condition of metal suitable for the polarizing glass is that the TE wave does not exhibit the plasma resonance absorption to the energy in the visible light region. That is, it means that ∈₁ hardly becomes 0, i.e., ∈₁→0, due to the influence of the hybrid plasma caused by the inter-band transition in the visible light region, i.e., the reflectivity hardly drops, and that the metal holds the high reflectivity. In this case, the reflectivity to the visual light is preferable to be 80% or more. Still more, the plasma resonance absorption of the TE wave to the polarizing glass preferably occurs to the TE wave of energy higher than 4.0 eV and the plasma resonance absorption of the TM wave to the polarizing glass preferably occurs to the TM wave of energy higher than 1.2 eV. Accordingly, Al and In meet with the second condition of the metal suitable for the polarizing glass based on FIGS. 4 and 7.

The polarizing glass using the metals that meet with the first and second conditions described above is produced as follows. At first, the base glass is melted and the above-mentioned metal and halogen are dispersed in the base glass to form mother material. After growing the metal particles by treating the mother material by heat, the metal particles are elongated to deform them into the shape of ellipsoid. Then, a reduction process is carried out to produce the polarizing glass. It is noted that the production method of the polarizing glass is not limited to the method described above. In this case, the polarizing glass using the metal that meets with the first and second conditions described above is preferable to have a contrast ratio of 100:1 or more in the visible light region. Still more, it is preferable for the metal particles within the polarizing glass to have the aspect ratio of 1.5:1 or more. Still more, in the polarizing glass in which the metal particles are dispersed and oriented, the transmittance in the visible light region is preferable to be 65% or more.

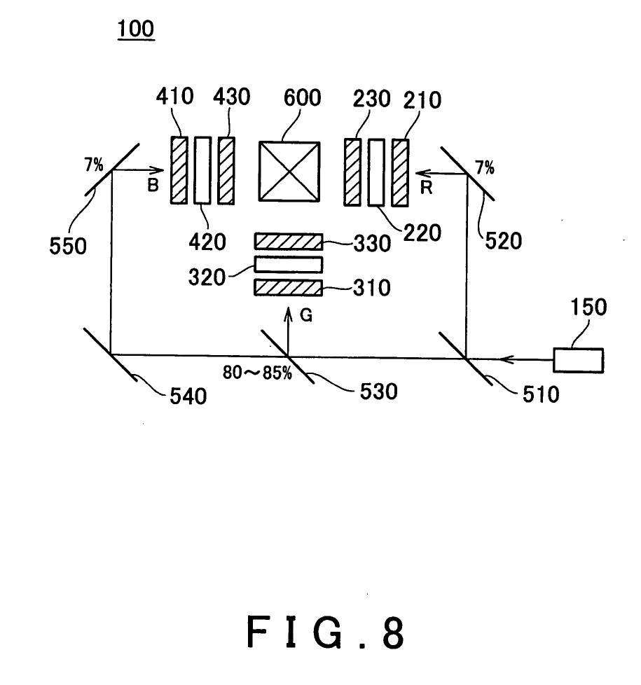

FIG. 8 is a diagrammatic view of a liquid crystal projector 100 that is another example of an embodiment. As shown in FIG. 8, incident light from a light source 150 is divided into lights of red, green and blue wavelength regions by half mirrors 510 and 530 and mirrors 520, 540 and 550. The light in the red wavelength region enters a red incident-side polarizing glass 210, the light in the green wavelength region enters a green incident-side polarizing glass 310 and the light in the blue wavelength region enters a blue incident-side polarizing glass 410, respectively.

After transmitting through the red incident-side polarizing glass 210, the light in the red wavelength region including the red light in the visible light region and infrared light transmits through an image displayed on a liquid crystal shutter 220. It then transmits through a red outgoing-side polarizing glass 230 and goes out to the outside through a prism 600 as red polarized light in the visible light region.

After transmitting through the blue incident-side polarizing glass 410, the light in the blue wavelength region including the blue light in the visible light region and ultraviolet light transmits through an image displayed on a liquid crystal shutter 420. It then transmits through a blue outgoing-side polarizing glass 430 and goes out to the outside through the prism 600 as blue polarized light in the visible light region. After transmitting through the green incident-side polarizing glass 310, the light of the wavelength region other than the light in the red wavelength region and the light in the blue wavelength region transmits through an image displayed on a liquid crystal shutter 320 and goes out to the outside through the prism 600 as green polarized light in the visible light region.

Thus, the liquid crystal projector 100 of the present embodiment obtains the polarized lights in the red, green and blue visible light regions by using the polarizing glass, instead of polarizing films used in the conventional liquid crystal projector. Accordingly, although the polarizing film disposed at the place of the blue incident-side polarizing glass 410 of the liquid crystal projector 100 of the embodiment has had a problem that it deteriorates due to ultraviolet light contained in the incident light in the blue wavelength region in the conventional liquid crystal projector, the blue incident-side polarizing glass 410 of the liquid crystal projector 100 of the embodiment has strong resistance against deterioration of light.

Still more, as for the polarizing films disposed at the places of the green incident-side polarizing glass 310 and the green outgoing-side polarizing glass 330 of the liquid crystal projector 100 of the embodiment, the conventional liquid crystal projector has had a possibility that pigments contained in the polarizing films are decomposed when these polarizing films are caused to absorb a part of the incident light, because a quantity of the incident light is 80 to 85% of a quantity of the light from a light source. In contrast to that, the green incident-side polarizing glass 310 and the green outgoing-side polarizing glass 330 of the liquid crystal projector 100 of the present embodiment cause no such decomposition of pigments in absorbing the incident light. Thus, as compared to the conventional liquid crystal projector, the liquid crystal projector 100 of the present embodiment has a long life and hardly causes deterioration of images.

Although the invention has been described by way of the exemplary embodiments, it should be understood that those skilled in the art might make many changes and substitutions without departing from the spirit and scope of the invention.

It is obvious from the definition of the appended claims that the embodiments with such modifications also belong to the scope of the invention.

What is claimed is:

1. Polarizing glass comprising:
a base glass exhibiting dichroism and formed of a transparent glass whose absorption edge of incident light is equal to or less than 350 nm when wavelength is converted into a variable; and
metal having anisotropic shape dispersed and oriented within said base glass, a real number part of dielectric constant of said metal being minus or crosses over 0 with energy higher than 3.5 eV when the energy is converted into a variable, and reflectivity of said metal being equal to or higher than 80% in the visible light region.

2. The polarizing glass as set forth in claim 1, wherein plasma resonance absorption of a TE wave to said polarizing glass takes place to said TE wave having energy higher than 4.0 eV.

3. The polarizing glass as set forth in claim 1, wherein plasma resonance absorption of a TM wave to said polarizing glass takes place to said TM wave having energy higher than 1.2 eV.

4. The polarizing glass as set forth in claim 2, wherein plasma resonance absorption of a TM wave to said polarizing glass takes place to said TM wave having energy higher than 1.2 eV.

5. The polarizing glass as set forth in claim 1, wherein transmittance in the visible light region is 65% or more.

6. The polarizing glass as set forth in claim 1, wherein a contrast ratio in the visible light region is 100:1 or more.

7. The polarizing glass as set forth in claim 1, wherein the absorption edge of said metal exists on the high-energy side higher than the absorption edge of said base glass when the energy is converted into a variable.

8. The polarizing glass as set forth in claim 1, wherein an aspect ratio of said metal is 1.5:1 or more.

9. The polarizing glass as set forth in claims 7, wherein an aspect ratio of said metal particle is 1.5:1 or more.

10. The polarizing glass as set forth in claim 1, wherein said metal comprises at least one of aluminum and indium.

11. A polarizing glass comprising:
a base glass exhibiting dichroism and formed of a transparent glass in which an absorption edge of incident light is equal to or less than 350 nm when wavelength is converted into a variable; and
metal dispersed and oriented within said base glass, said metal comprising at least one of aluminum and indium.
